(19) United States
(12) Patent Application Publication
(10) Pub. No.: US 2015/0114100 A1
(43) Pub. Date: Apr. 30, 2015

(54) LIQUID AMOUNT MEASURING DEVICE

(71) Applicant: AISAN KOGYO KABUSHIKI KAISHA, Aichi-ken (JP)

(72) Inventors: Masaki Ikeya, Aichi-ken (JP); Tetsuji Inoue, Aichi-ken (JP)

(73) Assignee: AISAN KOGYO KABUSHIKI KAISHA, Aichi-ken (JP)

(21) Appl. No.: 14/526,890

(22) Filed: Oct. 29, 2014

(30) Foreign Application Priority Data
Oct. 30, 2013 (JP) 2013-225867

(51) Int. Cl. G01F 23/38

(52) U.S. Cl. CPC G01F 23/38
USPC 73/114.54

(57) ABSTRACT

The fuel amount measuring device 10 comprises a plurality of detectors 22, 36 disposed within a vessel and an output circuit 38 configured to output an analog detection signal based on first analog signals outputted by the plurality of detectors. The analog detection signal corresponds to an amount of liquid within the vessel. Each of the plurality of detectors 22, 36 includes a float 24, 32; an arm member 26, 34 connected to the float such that vertical movement of the float is converted to rotational movement of the arm member, and a magnetic sensor 31, 41 configured to output a second analog signal corresponding to the rotational movement of the arm member. When the first analog signals outputted by the detectors 22, 36 are inputted to the output circuit 38, the output circuit 38 outputs the analog detection signal based on the inputted first analog signals.

### CROSS-REFERENCE TO RELATED APPLICATION

This application claims priority to Japanese Patent Application No. 2013-225867 filed on Oct. 30, 2013, the contents of which are hereby incorporated by reference into the present application.

### TECHNICAL FIELD

The present teachings relate to a liquid amount measuring device configured to measure an amount of liquid stored within a vessel (for example, a device configured to measure the amount of fuel stored within a fuel tank in an automobile or the like).

### DESCRIPTION OF RELATED ART

The liquid amount measuring device of this type may include a plurality of detectors disposed within a vessel. For example, a liquid amount measuring device disclosed in Japanese Patent Application Publication No. H5-288589 measures a liquid amount of fuel stored within a saddle-shaped fuel tank including a main storage part and a sub storage part. This liquid amount measuring device includes a resistance type fuel sender configured to detect a liquid level (liquid amount) of fuel stored within the main storage part and a resistance type fuel sender configured to detect a liquid level (liquid amount) of the fuel stored within the sub storage part. This plurality of fuel senders and a fuel meter are connected in series so that signals from this plurality of fuel senders are inputted to the fuel meter.

### BRIEF SUMMARY

The liquid amount measuring device disclosed in Japanese Patent Application Publication No. H5-288589 employs a resistance type detector. The resistance type detector can be affected by wear component and foreign matter and thus cannot measure the liquid level (liquid amount) accurately. Therefore, a use of a detector utilizing a magnetic sensor has been considered. However, in a case of the detector utilizing the magnetic sensor, when a plurality of detectors are to be disposed within a vessel, the plurality of detectors cannot be connected to a liquid amount meter in series, unlike the resistance type detector. Therefore, there has been a problem that many output signal lines are required because each signal must be outputted by each of the detectors directly to the liquid amount meter. The present teachings provide a liquid amount measuring device which can suppress an increase in output signal lines even when the plurality of detectors are disposed within the vessel in the case where the detector utilize the magnetic sensor.

The liquid amount measuring device disclosed in the present specification outputs a detection signal corresponding to an amount of liquid stored within a vessel. The liquid amount measuring device comprises a plurality of detectors disposed within the vessel and an output circuit configured to output an analog detection signal corresponding to the amount of liquid within the vessel based on first analog signals outputted by the plurality of detectors. Each of the plurality of detectors includes a float; an arm member connected to the float such that vertical movement of the float is converted to rotational movement of the arm member, and a magnetic sensor configured to output a second analog signal corresponding to the rotational movement of the arm member. When the first analog signals outputted by the detectors are inputted to the output circuit, the output circuit outputs the analog detection signal based on the inputted first analog signals.

In the above-described liquid amount measuring device, the first analog signals outputted by the plurality of detectors are inputted to the output circuit. The output circuit outputs the analog detection signal corresponding to the amount of the liquid within the vessel based on the first analog signals inputted by the plurality of detectors. Thus, the signals from the plurality of detectors are outputted via the output circuit to external equipment, thereby making it possible to suppress the increase in the signal output lines configured to connect the liquid amount measuring device and the external equipment.

### BRIEF DESCRIPTION OF DRAWINGS

FIG. 1 is a diagram showing a configuration of a liquid amount measuring device of an embodiment.

FIG. 2 is a diagram showing a circuit configuration of the liquid amount measuring device.

FIG. 3 is a diagram for explaining a function of a converter.

FIG. 4 is a diagram showing another embodiment of the circuit configuration of the liquid amount measuring device.

### DETAILED DESCRIPTION OF EMBODIMENTS

In the liquid amount measuring device disclosed in the present specification, a vessel may include a plurality of storage parts configured such that each of liquid levels of the storage parts changes independently. A detector may be disposed within each of the storage parts. An output circuit may include an adder configured to add voltage values of first analog signals outputted by the detectors. According to this configuration, a level (amount) of liquid stored within each of the storage parts is detected by each of the detectors and these detection results are added and outputted by the output circuit. This makes it possible to output the amount of the liquid stored within the vessel to external equipment.

It should be appreciated that a term “add” herein means not only an adding of the voltage values (for example, V1, V2) of the first analog signals outputted by the plurality of detectors without any change (for example, V1+V2) but also mean an adding of values obtained by multiplying the voltage values of these first analog signals respectively by a coefficient k (for example, k1×V1+k2×V2). Therefore, calculating of an average value (for example, ½×(V1+V2)) of the voltage values (for example, V1, V2) of the first analog signals outputted by the plurality of detectors, also applies to the “add” referred to herein.

In the liquid amount measuring device disclosed in the present specification, the vessel may be a saddle-shaped vessel, the vessel including a first storage part having a first depth, a second storage part having a second depth, and a connecting part connecting an upper portion of the first storage part to an upper portion of the second storage part, a depth of the connecting part being shallower than the first and second depth. In this case, one detector may be disposed within each of the first and second storage parts, and the output circuit may be disposed within the saddle-shaped vessel. According to this configuration, the first and second storage parts and the output circuit are disposed within the vessel, thereby making it possible to dispose signal lines configured to connect these components within the vessel.

In the liquid amount measuring device disclosed in the present specification, the vessel may include a plurality of storage parts configured such that each of liquid levels of the storage parts changes independently. A detector may be disposed within each of the storage parts. Each of the detectors may further include a converter configured to convert a second analog signal outputted by a magnetic sensor into the first analog signal corresponding to the liquid level of the storage part in which the detector is disposed. An output voltage value per liquid unit of each of the first analog signals outputted by the converters of the detectors may be a same value. According to this configuration, the analog signals outputted by each of the detectors are inputted via the converters to the output circuit. Here, the output voltage value per liquid unit of the first analog signal outputted by each of the converters is a same value. Therefore, the output circuit can easily process the analog signals outputted by the respective converters to output the analog detection signal corresponding to the amount of the liquid within the vessel even if maximum liquid amounts of the storage parts are different.

In the liquid amount measuring device having the above-described configuration, each of the converters of the detectors may convert the second analog signal outputted by the magnetic sensor based on a ratio of a maximum liquid amount of the vessel to a maximum liquid amount of the corresponding storage part. According to this configuration, scales (voltage values per liquid unit) of the analog signals outputted by each of the detectors can be made to be the same.

In the liquid amount measuring device having the above-described configuration, the converter of the detector selected among the plurality of detectors may convert the second analog signal outputted by the magnetic sensor of the selected detector by using a scale in which a maximum liquid amount of the storage part in which the selected detector is disposed corresponds to a predetermined set voltage value. In this case, the converter of each of the other detectors that were not selected may convert the second analog signal outputted by the magnetic sensor of the corresponding detector based on a ratio of the maximum liquid amount of the selected storage part to a maximum liquid amount of the corresponding storage part in which the other detector is disposed. Also according to such a configuration, the scales (voltage values per liquid unit) of the first analog signals outputted by the respective detectors can be made to be the same. Also, if the set voltage is set to be a maximum voltage value to be outputted by the detector, the selected detector can detect the amount of the liquid within the storage part by utilizing the full scale of the selected detector Thus, detection accuracy of the liquid amount can be improved.

In the liquid amount measuring device having the above-described configuration, each of the converters of the detectors may convert the second analog signal outputted by the magnetic sensor into a rotational angle of the corresponding arm member and convert the rotational angle of the corresponding arm member into the first analog signal corresponding to a liquid amount of the corresponding storage part. According to this configuration, the liquid amount is calculated based on the rotational angle of the arm member and thus the amount of the liquid stored within each of the storage parts can be accurately detected so that the amount of the liquid stored within the vessel can be detected.

### Embodiments

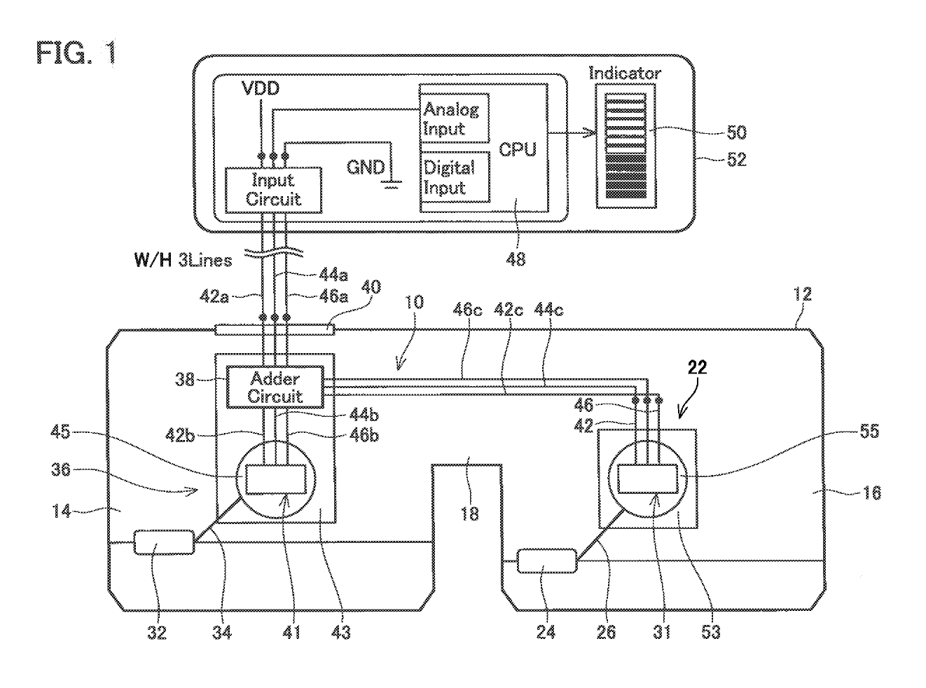

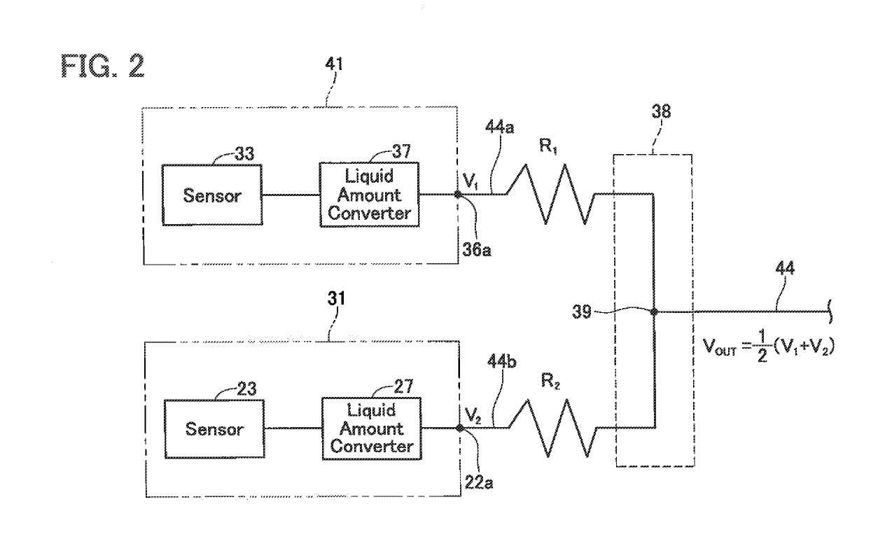

As shown in FIG. 1, a fuel amount measuring device 10 is disposed within a saddle-shaped fuel tank 12 equipped in an automobile. As shown in FIGS. 1 and 2, the fuel amount measuring device 10 includes a first fuel amount detector 36, a second fuel amount detector 22 and an adder circuit 38 (one example of an output circuit). The first and second fuel amount detectors 36 and 22 are connected via the adder circuit 38 to a fuel meter 52.

Firstly, the saddle-shaped fuel tank 12 in which the fuel amount measuring device 10 is disposed will be explained. In the fuel tank 12, a bottom face of a center part 18 (one example of a connecting part) is located higher than a bottom face of a main storage part 14 disposed on one side of the center part 18 and a bottom face of a sub storage part 16 disposed on the other side of the center part 18. Specifically, the center part 18 connects upper portions of the main and sub storage parts 14 and 16, and a depth of the center part 18 is made shallower than depths of the main and sub storage parts 14 and 16. Therefore, when an amount of fuel stored within the fuel tank 12 is decreased so that a liquid level becomes lower than the bottom face of the center part 18, the fuel is stored into the main and sub storage parts 14 and 16, independently of each other. Specifically, the liquid level of the fuel stored within the main storage part 14 and the liquid level of the fuel stored within the sub storage part 16 can change independently. As a result, even if the amount of the fuel stored within the main storage part 14 alone is detected, a total amount of the fuel stored within the fuel tank 12 cannot be calculated accurately. Similarly, even if the amount of the fuel stored within the sub storage part 16 alone is detected, the total amount of the fuel stored within the fuel tank 12 cannot be calculated accurately. Hence, the fuel amount measuring device 10 of this embodiment detects the amount of the fuel within the main storage part 14 and the amount of the fuel within the sub storage part 16, respectively.

It should be noted that a fuel pump (not shown) is disposed in the main storage part 14 of the fuel tank 12. The fuel pump sucks the fuel within the fuel tank 12 (specifically, within the main storage part 14) to be boosted, and supplies the boosted fuel outside the fuel tank 12 (namely, engine). On the other hand, since the fuel pump is disposed in the main storage part 14, it is necessary to transfer the fuel within the sub storage part 16 to the main storage part 14 when the liquid level of the fuel within the fuel tank 12 is lowered. The transfer of the fuel from the sub storage part 16 to the main storage part 14 is configured to be carried out by acceleration/deceleration of a speed during running or centrifugal farce during turning, or to be carried out by a jet pump (not shown) which utilizes a part of the fuel discharged from the fuel pump.

The first fuel amount detector 36 is disposed within the main storage part 14. The first fuel amount detector 36 includes a float 32, an arm member 34 fixed on the float 32, a rotor 45 fixed at a base end of the arm member 34 and a magnetic sensor unit 41 configured to detect a rotational angle of the rotor 45. The float 32 floats on the fuel within the main storage part 14 and moves vertically in correspondence to the liquid level of the fuel. A tip end of the arm member 34 is fixed on the float 32. The rotor 45 is fixed on the base end of the arm member 34. The rotor 45 is made of a permanent magnet or the like so as to generate a predetermined magnetic field. The rotor 45 is rotatably supported on a casing 43. The magnetic sensor unit 41 is disposed in the casing 43. The magnetic sensor unit 41 detects the magnetic field generated by the rotor 45. Therefore, the vertical movement of the float 32 corresponding to the liquid level of the fuel within the main storage part 14 causes the arm member 34 to swing and the rotor 45 to rotate relative to the casing 43. Upon rotation of the rotor 45, an orientation of the magnetic field generated by the rotor 45 changes. Then, the orientation and intensity of the magnetic field of the rotor 45 detected by the magnetic sensor unit 41 change. The magnetic sensor unit 41 outputs an analog signal corresponding to the amount of the fuel stored within the main storage part 14 based on the detected orientation and intensity of the magnetic field of the rotor 45 (see FIG. 2). A detailed configuration of the magnetic sensor unit 41 will be described later.

The second fuel amount detector 22 has a same configuration as the first fuel amount detector 36 and includes a float 24, an arm member 26, a rotor 55 and a magnetic sensor unit 31. The float 24 moves in a vertical direction corresponding to a liquid level of the fuel within the sub storage part 16 and the vertical movement of the float 24 causes the arm member 26 to swing and causes the rotor 55 to rotate relative to the casing 53. The magnetic sensor unit 31 detects a rotational movement of the rotor 55 (specifically, the magnetic field of the rotor 55) and outputs an analog signal corresponding to the amount of the fuel stored within the sub storage part 16 based on a detection result (see FIG. 2) hereby obtained. A detailed configuration of the magnetic sensor unit 31 will be described later.

The adder circuit 38 is equipped in the casing 43 in which the first fuel amount detector 36 is disposed. Since the casing 43 is disposed within the fuel tank 12 (specifically, within the main storage part 14), the adder circuit 38 is also disposed within the fuel tank 12. The adder circuit 38 is connected to the fuel meter 52 disposed outside the fuel tank 12 (for example, a driver's seat) and also connected to the first and second fuel amount detectors 36 and 22 disposed within the fuel tank 12. Specifically, the adder circuit 38 and the first fuel amount detector 36 are connected by a power source line 42b, a ground line 46b and a signal output line 44b. The first fuel amount detector 36 is actuated by power supplied from the power source line 42b to output the amount of the fuel stored within the main storage part 14 to the signal output line 44b. The adder circuit 38 and the second fuel amount detector 22 are connected by a power source line 42c, a ground line 46c and a signal output line 44c. The second fuel amount detector 22 is actuated by power supplied from the power source line 42c to output the amount of the fuel stored within the sub storage part 16 to the signal output line 44c. Since the adder circuit 38 is disposed within the fuel tank 12, the above-described lines 42b, 42c, 44b, 44c, 46b and 46c are also disposed within the fuel tank 12.

The adder circuit 38 and the fuel meter 52 are connected by a power source line 42a, a ground line 46a and a signal output line 44a. Thus, power supplied from the fuel meter 52 is supplied via the power source lines 42a and 42b to the first fuel amount detector 36 and also supplied via the power source lines 42a, 42c to the second fuel amount detector 22. On the other hand, the outputted signal from the first fuel amount detector 36 (amount of the fuel within the main storage part 14) and the outputted signal from the second fuel amount detector 22 (amount of the fuel within the sub storage part 16) are added by the adder circuit 38 to form an analog signal corresponding to the amount of the fuel within the fuel tank 12 and the formed analog signal is inputted to the fuel meter 52 by the signal output line 44a. As described above, the adder circuit 38 is disposed within the fuel tank 12. Therefore, the lines (the power source line 42a, the ground line 46a and the signal output line 44a) configured to connect the adder circuit 38 and the fuel meter 52 penetrate a lid member 40 configured to close an opening of the fuel tank 12 to extend from the inside of the fuel tank 12 to the outside thereof. A detailed configuration of the adder circuit 38 will be described later.

It should be noted that the fuel meter 52 is provided with a CPU 48 and an indicator 50. The analog signal outputted from the adder circuit 38 is inputted to the CPU 48. The CPU 48 determines the amount of the fuel stored within the fuel tank 12 based on the analog signal inputted from the adder circuit 38 and indicates the determined fuel amount on the indicator 50. The CPU 48 and the indicator 50 can be configured in a similar manner to those of conventionally known fuel meters.

Next, the magnetic sensor units 41 and 31 and the adder circuit 38 will be explained in detail. As shown in FIG. 2, the magnetic sensor unit 41 includes a magnetic sensor 33 and a converter 37. The magnetic sensor 33 is a magnetic type sensor configured to detect a rotational angle of the rotor 45 (namely, a rotational angle of the arm member 34) and for example, a known sensor utilizing a hole element can be used as the magnetic sensor 33. The magnetic sensor 33 outputs an output signal (analog signal) corresponding to the rotational angle of the rotor 45.

The converter 37 converts the output signal (analog signal) inputted from the magnetic sensor 33 to an analog signal corresponding to the amount of the fuel stored within the main storage part 14. Specifically, the converter 37 includes table data configured to convert the output signal (analog signal) from the magnetic sensor 33 to the amount of the fuel stored within the main storage part 14. Specifically, a voltage value of the output signal (analog signal) from the magnetic sensor 33 changes depending on the rotational angle of the rotor 45. The rotational angle of the rotor 45 is a rotational angle of the arm member 34. Therefore, the rotational angle of the rotor 45 changes depending on the liquid level of the fuel stored within the main storage part 14. Since a shape (transverse sectional shape) of the main storage part 14 is known, the amount of the fuel stored within the main storage part 14 can be determined if the liquid level of the fuel stored within the main storage part 14 is specified. Thus, the converter 37 converts the output signal (analog signal) of the magnetic sensor 33 to an analog signal corresponding to the amount of the fuel stored within the main storage part 14, using the table data configured to define a relation of “the output signal (voltage value) of the magnetic sensor 33—the fuel amount of the main storage part 14.” The “fuel amount” of the main storage part 14 converted by the converter 37 is outputted to the adder circuit 38 as an analog signal V1. As is evident from the above explanation, the table data changes depending on the shape of the main storage part 14. Therefore, the table data is preliminarily created in accordance with the shape of the main storage part 14 and the created table data is stored in a memory of the converter 37.

The magnetic sensor unit 31 includes a magnetic sensor 23 and a converter 27, similarly to the magnetic sensor unit 41. The magnetic sensor 23 is configured similarly to the magnetic sensor 33 to detect a rotational angle of the rotor 55 (arm member 26). The converter 27 is configured similarly to the converter 37 to convert an output of the magnetic sensor 33 to the amount of the fuel stored within the sub storage part 16, using table data for the sub storage part 16. The “fuel amount” of the sub storage part 16 calculated by the converter 27 is outputted to the adder circuit 38 as an analog signal V2.

Here, the output signal (analog signal) outputted by the first fuel amount detector 36 (converter 37) and the output signal (analog signal) outputted by the second fuel amount detector 22 (converter 27) are added by the adder circuit 38 which will be described later. In this embodiment, a scale of the signal outputted by the first fuel amount detector 36 (output voltage value per fuel unit) and a scale of the signal outputted by the second fuel amount detector 22 (output voltage value per fuel unit) are made to be a same value for easy processing in the adder circuit 38. Specifically, the relation of the “voltage value”-“fuel amount” stored in the respective detectors 36 and 22 is stored so that the scale of the output signal outputted by the first fuel amount detector 36 and the scale of the output signal outputted by the second fuel amount detector 22 are the same.

For example, it is assumed that a maximum fuel amount Q1 of fuel can be stored within the main storage part 14 and that a maximum fuel amount Q2 of fuel can be stored within the sub storage part 16. In such a case, the output voltage value per fuel unit is defined as Vu. In this case, the signals from the magnetic sensors 23, 33 are converted by the converters 37, 27 so that a minimum value of the signal outputted by the first fuel amount detector 36 is V0 and a maximum value thereof is V0+Vu×Q1, and that a minimum value of the signal outputted by the second fuel amount detector 22 is V0 and a maximum value thereof is V0+Vu×Q2. Thus, the scales of the signals outputted by the first and second fuel amount detectors 36 and 22 become the same, thereby enabling easy processing in the adder circuit 38. Here, the V0 is a clamp voltage (lower limit) set, for example, to determine a malfunction of the detectors 36, 22.

Also, in another example, in a case where the maximum fuel amount Q1 can be stored within the main storage part 14 and the maximum fuel amount Q2 can be stored within the sub storage part 16, the signal outputted by the first fuel amount detector 36 is weighted by a coefficient (Q1/(Q1+Q2)) and the signal outputted by the second fuel amount detector 22 is weighted by a coefficient (Q2/(Q1+Q2)). The above method also can make the scales of the signals outputted by the first and second fuel amount detectors 36 and 22 to be the same, thereby enabling the easy processing in the adder circuit 38.

The adder circuit 38 adds the analog signal V1 outputted by the first fuel amount detector 36 and the analog signal V2 outputted by the second fuel amount detector 22 to output this added signal Vout (specifically, output Vout=average value ((V1+V2)/2). In other words, as shown in FIG. 2, an output terminal 36a of the first fuel amount detector 36 is connected to a connection point 39 via a resistance R1 and an output terminal 22a of the second fuel amount detector 22 is connected to the connection point 39 via a resistance R2. The connection point 39 is connected to an input terminal of the fuel meter 52. Therefore, the voltage Vout at the connection point 39 is a value obtained by proportionally dividing the output voltage V1 of the first fuel amount detector 36 and the output voltage V2 of the second fuel amount detector 22 by the resistances R1, R2. In this embodiment, the values of the resistances R1 and R2 are made to be the same and thus the signal outputted from the adder circuit 38 is an average value ½×(V1+V2) of the output voltages V1, V2.

The signal Vout (=(V1+V2)/2) outputted from the adder circuit 38 is inputted to the fuel meter 52. Since the scales of the signals V1, V2 outputted by the respective detectors 36, 22 are known, the CPU 48 of the fuel meter 52 can accurately calculate the amount of the fuel stored within the fuel tank 12 based on the signal Vout inputted from the adder circuit 38.

The voltages of the signals inputted/outputted to the magnetic sensors 33, 23 and the fuel meter 52 is set to normally range from 0 to power source voltage (for example, 5 V). Thus, detection accuracy of the first or second fuel amount detector 36 or 22 can be enhanced by setting a voltage (upper limit clamp voltage) at full scale of the signal V1, V2 outputted from the first or second fuel amount detector 36 or 22 to be a set voltage near the power source voltage. Normally, in the saddle-shaped fuel tank 12, the volume Q1 of the main storage part 14 is larger than the volume Q2 of the sub storage part 16. Therefore, detection accuracy of the fuel amount measuring device 10 can be suitably enhanced by setting a voltage (upper limit clamp voltage) at full scale of the signal V1 outputted by the first fuel amount detector 36 to be the set voltage near the power source voltage. It should be noted that in this case, the voltage (upper limit clamp voltage) at full scale of the signal outputted by the second fuel amount detector 22 may be determined based on a ratio of the volume Q1 of the main storage part 14 to the volume Q2 of the sub storage part 16.

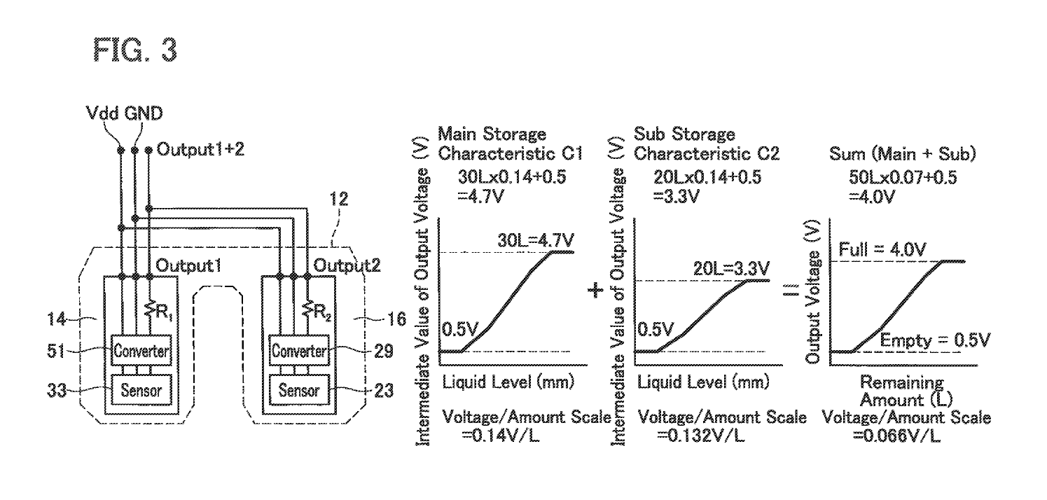

A specific example will be explained using FIG. 3. In an example shown in FIG. 3, the volume of the main storage part 14 is 30 liters, and the volume of the sub storage part 16 is 20 liters. Also, the power source voltage is defined as 5 V, and the lower limit clamp voltage V0 is defined as 0.5 V. In this case, the upper limit clamp voltage of the first fuel amount detector 36 configured to detect the fuel amount of the main storage part 14 is firstly set to a set voltage (4.7 V) near the power source voltage. Thus, the signal outputted by the first fuel amount detector 36 ranges from 0.5 V to 4.7 V. Since 30 liters of the fuel is stored in the main storage part 14, the voltage value per fuel unit is 0.14 V/liter. Next, the upper limit clamp voltage of the second fuel amount detector 22 is to be set. A ratio of the volume of the main storage part 14 to the volume of the sub storage part 16 is 3:2. Therefore, the upper limit clamp voltage of the second fuel amount detector 22 is 4.2×⅔+0.5=3.3 V. Thus, the signal outputted by the second fuel amount detector 22 ranges from 0.5 V to 3.3 V. Since 20 liters of the fuel is stored in the sub storage part 16, the voltage value per fuel unit is 0.14 V/liter.

The adder circuit 38 outputs an average value Vout (=(V1+V2)/2) of the output signal V1 of the first fuel amount detector 36 and the output signal V2 of the second fuel amount detector 22. Therefore, a signal ranging from 0.5 V to 4.0 V is inputted to the fuel meter 52 such that the voltage value per fuel unit is 0.07 V/1. Thus, the voltage inputted to the fuel meter 52 also ranges from 0 V to 4.7 V (set voltage). However, there is a case where, as a result of setting of the upper and lower limit clamp voltages of the first and second fuel amount detectors 36 and 22, the voltage of the signal inputted to the fuel meter 52 exceeds the set voltage. In this case, the upper and lower limit clamp voltages of the first and second fuel amount detectors 36 and 22 can be appropriately corrected such that the maximum value of the voltage of the signal inputted to the fuel meter 52 becomes 4.7 V (set voltage).

As is evident from the above explanation, the fuel amount measuring device 10 of this embodiment measures the fuel amount of the main storage part 14 by the first fuel amount detector 36 and measure the fuel amount of the sub storage part 16 by the second fuel amount detector 22 to add these fuel amounts by the adder circuit 38 to be outputted to the fuel meter 52. Therefore, this configuration can make the number of signal output lines configured to connect the fuel amount measuring device 10 and the fuel meter 52 to be one.

Further, the signals from the magnetic sensors 33, 23 in the respective detectors 36, 22 are converted so that the scale (voltage value per fuel unit) of the signal V1 outputted by the first fuel amount detector 36 and the scale (voltage value per fuel unit) of the signal V2 outputted by the second fuel amount detector 22 are the same. Therefore, the adder circuit 38 needs only to be connected with the output terminal 36a of the first fuel amount detector 36 and the output terminal 22a of the second fuel amount detector 22 and to connect the connection point of these terminals to the input terminal of the fuel meter 52. Hence, the adder circuit 38 can be configured by a quite simple structure.

Also, since the adder circuit 38 is disposed within the fuel tank 12, the lines connecting the adder circuit 38 and the fuel amount detectors 36, 22 can be disposed within the fuel tank 12. Thus, only lines configured to connect the adder circuit 38 and the fuel meter 52 extend through the fuel tank 12 from the inside thereof to the outside thereof, thereby reducing the number of these lines. As a result, the number of sealed places of the fuel tank 12 is decreased, thereby making it possible to enhance a sealability of the fuel tank 12.

While specific embodiments of the present invention have been described above in detail, these embodiments are merely illustrative and place no limitation on the scope of the patent claims. The technology described in the patent claims also encompasses various changes and modifications to the specific embodiments described above.

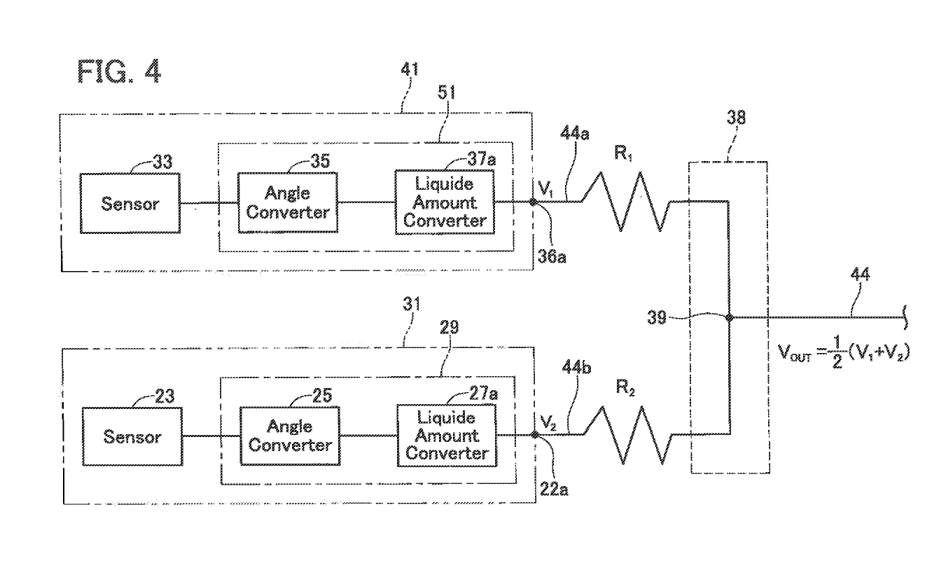

For example, in the above-described embodiments, the signals outputted from the magnetic sensors 33, 23 are directly converted to the amounts of the fuel stored in the storage parts 14, 16 but the technique disclosed in the present specification is not limited to such embodiments. For example, as shown in FIG. 4, a converter 51 of the magnetic sensor unit 41 may be configured of an angle converter 35 configured to convert an output signal (analog signal) from the magnetic sensor 33 to a rotational angle of the arm member 34 and a liquid amount converter 37a configured to convert a converted rotational angle of the arm member 34 to an amount of the fuel stored within the main storage part 14. Similarly, a converter 29 of the magnetic sensor unit 31 may be configured of an angle converter 25 and a liquid amount converter 27a.

Specifically, the angle converters 35, 25 preliminarily store a relation between the voltage values of the output signals from the magnetic sensors 33, 23 and the rotational angles of the arm members 34, 26 (relation of “voltage value”-“rotational angle”). Therefore, upon input of the output signals from the magnetic sensors 33, 23, the angle converters 35, 25 determine the rotational angles of the arm members 34, 26 based on the output signals that have been inputted.

The liquid amount converters 37a, 27a calculate the amounts of the fuel stored within the storage parts 14, 16 based on the rotational angles of the arm members 34, 26 determined by the angle converters 35, 25. Specifically, if the rotational angles of the arm members 34, 26 are determined, the liquid levels of the fuel within the respective storage parts 14, 16 can be determined based on these rotational angles. Since shapes (transverse sectional shapes) of the storage parts 14, 16 are known, the liquid amount converters 37a, 27a calculate the “amounts of the fuel” stored within the storage parts 14, 16 based on the relation between the “rotational angles” of the arm members 34, 26 and the “amounts of the fuel” stored within the storage parts 14, 16 (relation of “rotational angle”-“fuel amount”).

It should be noted that the relation between the “liquid level” of the sub storage part 16 and the “rotational angle” of the arm member 26 is determined depending on a length of the arm member 26. Therefore, if the arm member 26 and the arm member 34 have the same length, the relation of “voltage value”-“rotational angle” stored in the angle converter 25 is identical with the relation of “voltage value”-“rotational angle” stored in the angle converter 35. On the other hand, the relation of “rotational angle”-“fuel amount” stored in the liquid amount converter 27a is determined depending on the transverse sectional shape of the sub-storage part 16. Therefore, if the main storage part 14 and the sub storage part 16 have different shapes, the relation of “rotational angle”-“fuel amount” stored in the liquid amount converter 27a is different from that stored in the liquid amount converter 37a.

In the above embodiments, the fuel amount measuring device disposed in the saddle-shaped fuel tank 12 has been explained but the technique disclosed in the present specification is not limited to such embodiments. For example, the technique can be applied also to a case where fuel is stored in a plurality of independent fuel tanks. In this case, a fuel amount detector is arranged in each of the fuel tanks and detection results of these detectors are outputted to a fuel meter via an adder circuit.

The volume of the main storage part 14 and the volume of the sub storage part 16 are different from each other in the above embodiments but may be identical with each other. In this case, since the scales (voltage values per fuel unit) of the signals outputted by the respective fuel amount detectors 36, 22 are the same, the conversion for matching the scales is unnecessary.

In the above embodiments, the two storage parts 14, 16 are provided in the fuel tank 12 and the fuel amount detectors 36, 22 are arranged in these storage parts 14, 16. However, three or more storage parts may be provided in the fuel tank. In this case, it is only necessary to arrange a fuel amount detector in each of the storage parts, to input output signals by the respective fuel amount detectors to an adder and to add the output signals in the adder.

The technical elements explained in the present description or drawings provide technical utility either independently or through various combinations. The present invention is not limited to the combinations described at the time the claims are filed. Further, the purpose of the embodiments illustrated by the present description or drawings is to satisfy multiple objectives simultaneously, and satisfying any one of those objectives gives technical utility to the present invention.

What is claimed is:

1. A liquid amount measuring device, comprising:
a plurality of detectors disposed within a vessel; and
an output circuit configured to output an analog detection signal based on first analog signals outputted by the plurality of detectors, the analog detection signal corresponding to an amount of liquid within the vessel;
wherein each of the plurality of detectors includes a float; an arm member connected to the float such that vertical movement of the float is converted to rotational movement of the arm member, and a magnetic sensor configured to output a second analog signal corresponding to the rotational movement of the arm member, and
when the first analog signals outputted by the detectors are inputted to the output circuit, the output circuit outputs the analog detection signal based on the inputted first analog signals.

2. The liquid amount measuring device as in claim 1, wherein
the vessel includes a plurality of storage parts configured such that each of liquid levels of the storage parts changes independently,
one detector is disposed within each of the storage parts, and
the output circuit further includes an adder configured to add voltage values of the first analog signals outputted by the detectors.

3. The liquid amount measuring device as in claim 2, wherein
the vessel is a saddle-shaped vessel, the vessel including a first storage part having a first depth, a second storage part having a second depth, and a connecting part connecting an upper portion of the first storage part to an upper portion of the second storage part, a depth of the connecting part being shallower than the first and second depths,
one detector is disposed within each of the first and second storage parts, and
the output circuit is disposed within the vessel.

4. The liquid amount measuring device as in claim 1, wherein
the vessel includes a plurality of storage parts configured such that each of liquid levels of the storage parts changes independently,
one detector is disposed within each of the storage parts,
each of the detectors includes a converter configured to convert the second analog signal outputted by the magnetic sensor into the first analog signal corresponding to the liquid level of the storage part in which the detector is disposed, and
an output voltage value per liquid unit of each of the first analog signals outputted by the converters of the detectors is a same value.

5. The liquid amount measuring device as in claim 4, wherein each of the converters of the detectors converts the second analog signal outputted by the magnetic sensor based on a ratio of a maximum liquid amount of the vessel to a maximum liquid amount of the corresponding storage part.

6. The liquid amount measuring device as in claim 4, wherein
the converter of the detector selected among the plurality of detectors converts the second analog signal outputted by the magnetic sensor of the selected detector by using a scale in which a maximum liquid amount of the storage part in which the selected detector is disposed corresponds to a predetermined set voltage value, and
the converter of each of the other detectors that were not selected converts the second analog signal outputted by the magnetic sensor of the corresponding detector based on a ratio of the maximum liquid amount of the selected storage part to a maximum liquid amount of the corresponding storage part in which the other detector is disposed.

7. The liquid amount measuring device as in claim 4, wherein each of the converters of the detectors converts the second analog signal outputted by the magnetic sensor into a rotational angle of the corresponding arm member, and converts the rotational angle of the corresponding arm member into the first analog signal corresponding to a liquid amount of the corresponding storage part.
